(19) United States
(12) Patent Application Publication
(10) Pub. No.: US 2004/0188659 A1
(43) Pub. Date: Sep. 30, 2004

(54) Conductor composition and uses thereof

(75) Inventors: Hideyuki Tomita, Nagoya (JP); Atsushi Nagai, Nagoya (JP)

Correspondence Address: OLIFF & BERRIDGE, PLC, P.O. BOX 19928, ALEXANDRIA, VA, 22320, US

(73) Assignee: NORITAKE CO., LIMITED, Nagoya (JP)

(21) Appl. No.: 10/807,277

(22) Filed: Mar. 24, 2004

(30) Foreign Application Priority Data
Mar. 24, 2003 (JP) 2003-081303

(51) Int. Cl. B32B 15/04

(52) U.S. Cl. 252/500; 75/252; 427/100

(57) ABSTRACT

The present invention provides a conductor composition that is prepared in the form of an ink or a paste and is for forming conductor films having excellent heat resistance on a piezoelectric ceramic material. This composition comprises a platinum powder that is a principal conductor-forming component, and a rare earth oxide powder having a mean particle size in a range of approximately 10 to approximately 100 nm.

This application claims priority to Japanese Patent Application No. 2003-81303, filed on Mar. 24, 2003, the entire contents of which are incorporated herein by reference.

### BACKGROUND OF THE INVENTION

1. Field of the Invention

The present invention relates to a conductor composition that can be suitably used for forming a conductor film on a piezoelectric ceramic material such as PZT (lead zirconate titanate), and more specifically to such a conductor composition prepared in the form of an ink or a paste (hereinafter such a preparation is referred to as a ‘conductor paste’).

2. Description of the Related Art

Piezoelectric ceramic materials such as PZT (lead zirconate titanate: Pb(Zr,Ti)O₃), which comprises a solid solution of lead zirconate (PbZrO₃) and lead titanate (PbTiO₃), are used for substrates for various piezoelectric elements such as piezoelectric transformers, actuators and ultrasonic vibrators. To construct such a piezoelectric element, a conductor paste is used as a material for forming a conductor film in a prescribed pattern (wiring, electrodes etc.) on the piezoelectric ceramic material (dielectric).

The conductor paste is a conductor-forming material prepared by dispersing a metal powder, which is the principal component for forming the conductor, and any of various additives that are added as necessary (inorganic binders, glass frit, fillers etc.) in a prescribed organic medium.

The conductor paste is printed or applied onto the piezoelectric ceramic material (substrate) using a common technique such as screen printing. Next, the applied material (coating film) is baked at a suitable temperature, whereby a conductor film having a prescribed pattern can be formed on the piezoelectric ceramic material (substrate).

As electrical equipment has become more advanced and complex in recent years, there has been progress in making the circuitry be multi-layered for piezoelectric elements. Such a laminate type piezoelectric element typically has a construction in which a plurality of (typically a few tens to a few hundreds of) sheet-like substrates each comprising a piezoelectric ceramic material having a conductor film (internal electrodes) formed thereon are built up on top of one another.

An example of a conductor paste suitable for forming conductors (in particular, internal electrodes disposed inside such a laminate type element) in such a laminate type piezoelectric element (laminate type piezoelectric ceramic substrate) is a conductor paste having platinum (Pt) as the principal component for conductor film formation (hereinafter referred to as a ‘Pt paste’). Platinum has a high melting point, and also has low reactivity with ceramics, and hence is preferable as a metallic material for forming conductors on a piezoelectric ceramic material baked at a relatively high temperature (e.g. 1200 to 1300° C.). Pt pastes are thus used for forming conductors (internal electrodes) in laminate type piezoelectric actuators. For example, Japanese Patent Application Laid-open No. 11-242913 and Japanese Patent Application Laid-open No. 2001-184942 describe prior examples of Pt pastes suitable for forming conductors (electrodes) of ceramic substrates.

Broadly speaking, there are the following two methods for forming a laminate type piezoelectric element. In the first method, green sheets made of a piezoelectric ceramic having had conductor films (internal electrodes) formed on the surfaces thereof in advance using a conductor paste such as a Pt paste are laminated in order in an unbaked state, and then the laminate is all baked at once.

In the second method, conductors (internal electrodes) are formed on a green sheet made of a piezoelectric ceramic and the sheet is baked, and then another piezoelectric ceramic green sheet is laminated onto the baked sheet (substrate), conductors (internal electrodes) are formed, baking is again carried out, and so on, i.e. a sequence comprising green sheet lamination, internal electrode formation (conductor paste application) and baking is carried out repeatedly.

With this second method, baking is repeated many times before the manufacture of the laminate type piezoelectric ceramic substrate is completed. Moreover, even if the first method is used, after the laminate has been formed, baking (high-temperature treatment) is carried out again when forming external electrodes on the outside of the laminate. A property required of the material from which the internal electrodes in a piezoelectric ceramic laminate are formed is thus excellent heat resistance, with characteristics of the conductors (e.g. resistance, film thickness, density, strength of adhesion to the substrate) not being prone to changing upon repeated exposure to high temperature (e.g. 1000 to 1300° C.). The development of an improved Pt paste enabling formation of such highly durable conductors is thus desired.

Hitherto, many conductor-forming materials (conductor pastes) for which thermal shrinkage and so on of conductors is suppressed and adhesion to a ceramic material (substrate) is improved have been proposed. For example, in Japanese Patent Application Laid-open No. 2000-106035 there is described a conductive paste composition in which the surface of a metal powder that constitutes the principal component for conductor formation is coated with copper oxide. In Japanese Patent Application Laid-open No. 2001-240901, there is described a surface-embellished silver powder for a circuit-forming baking paste having a specific oxide or composite oxide fixed thereto. In Japanese Patent Application Laid-open No. 11-71601, there is described a powder material for a paste for internal electrodes constituted from crystalline Pd particles coated with an amorphous silicon oxide surface layer. In Japanese Patent Application Laid-open No. 9-129028, there is described a method of manufacturing a metal powder having an inorganic coating film. In Japanese Patent Application Laid-open No. 7-176209, there is described a silver/palladium paste comprising a silver/palladium powder as a principal conductor-forming component, an organotitanium compound for increasing the adhesive strength, and an additive for controlling sintering shrinkage. In Japanese Patent Application Laid-open No. 7-320535, there is described a copper paste that has a copper-based metal powder as a principal component thereof and contains a metal oxidizing agent.

However, the art disclosed in the above patent documents does not have as an object thereof improving the quality of a conductor film of a platinum paste formed on a piezoelectric ceramic material.

### SUMMARY OF THE INVENTION

It is an object of the present invention to provide a Pt paste that enables formation of high-quality conductors having excellent heat resistance on a piezoelectric ceramic material such as PZT. Moreover, it is another object to provide a method of forming high-quality conductor films (typically internal electrodes) on a piezoelectric ceramic material such as PZT using such a Pt paste, and a piezoelectric element (in particular a laminate type piezoelectric element) having such conductor films and a method of manufacturing the piezoelectric element.

A composition disclosed here is a conductor composition (conductor paste) prepared in the form of an ink or a paste. This conductor paste has a platinum powder as a principal conductor-forming component. This Pt paste preferably contains a rare earth oxide powder having a mean particle size in a range of approximately 10 to approximately 100 nm. The Pt paste can be suitably used for forming a conductor film baked on a substrate made of a piezoelectric ceramic.

Consequently, according to another aspect of the present invention, there is provided a method of forming a conductor film on PZT or another piezoelectric ceramic material (such as barium titanate) characterized by using any of the Pt pastes disclosed here (in the case that a laminate is formed from the piezoelectric ceramic material, the conductor formed will typically correspond to an internal electrode in the laminate).

As a result of the Pt paste of the present invention having mixed therein a rare earth oxide powder having a mean particle size in a range of approximately 10 to approximately 100 nm, the platinum-based conductor film formed on the piezoelectric ceramic material such as PZT is dense, and the heat resistance is improved. That is, with a conductor film formed from the Pt paste disclosed here, even upon repeated baking, thermal shrinkage is not prone to occurring, and hence cracking can be suppressed. Moreover, adhesion to the piezoelectric ceramic material is excellent, and hence the occurrence of voids, warping and so on can be suppressed. Furthermore, even upon being exposed to a high temperature many times such as in the case of repeated baking, the electrical resistance of the conductor film itself is not prone to changing. The conductor paste of the present invention is thus suitable as a conductor composition for forming a conductor film on a piezoelectric ceramic material consisting mainly of PZT (lead zirconate titanate) for which changes in properties upon baking are marked. If the Pt paste of the present invention is used, then it is possible to manufacture piezoelectric ceramic substrates having formed thereon conductor films (e.g. internal electrodes) having high electrical reliability and heat resistance, and electronic components having such substrates as principal constituent elements thereof.

The Pt paste disclosed here preferably contains the rare earth oxide powder in a proportion of approximately 0.1 to approximately 3 parts by mass per 100 parts by mass of the platinum powder. By mixing the rare earth oxide powder and the platinum powder together in such a mass ratio, a conductor film having particularly good heat resistance can be formed.

Moreover, it is preferable for the Pt paste to contain yttrium oxide as the rare earth oxide powder. Alternatively, the Pt paste may contain at least one cerium group rare earth oxide (typically cerium oxide). Through containing such an oxide, the heat resistance of the platinum-based conductor film can be particularly improved.

Moreover, the present invention provides a method of manufacturing a piezoelectric element (this refers to an electronic component having a piezoelectric ceramic substrate as a principal constituent element thereof; likewise hereinafter) characterized by using any of the Pt pastes disclosed in the present specification. Specifically, the present method comprises a step of preparing a conductor composition prepared in the form of an ink or a paste comprising a platinum powder that is a principal conductor-forming component, and preferably comprising a rare earth oxide powder having a mean particle size in a range of approximately 10 to approximately 100 nm, a step of applying the composition onto a substrate made of a piezoelectric ceramic material, and a step of baking the substrate onto which the conductor composition (paste) has been applied.

According to this method, it is possible to manufacture a highly reliable piezoelectric element (transformer, actuator etc.) having highly heat-resistant conductor films. As a preferable example, it is possible to manufacture a laminate type piezoelectric element by building up a large number of piezoelectric ceramic substrates (green sheets) in order while forming internal electrodes thereon, and repeating a baking step as necessary.

Preferably, a ceramic material constituted substantially from PZT is used for each of the substrates. As a result, a highly reliable PZT-based piezoelectric element having excellent heat resistance can be suitably manufactured.

Moreover, in this case, there is provided a method characterized by carrying out the baking in an atmosphere containing PZT. Here, an atmosphere containing PZT refers to an atmosphere that contains PbO, ZrO₂ and TiO₂ vapors, or PbZrO₃ vapor with excess Pb vapor, and has a low oxygen content.

Under such a PZT-containing atmosphere, PZT-based piezoelectric ceramic substrates can be sintered to high density. If the Pt paste disclosed here is used, then conductor films having excellent heat resistance and adhesion can be formed on such high-density sintered substrates.

According to the Pt paste disclosed here, heat resistance is excellent, with it being possible to reduce changes in characteristics upon repeated baking. If the Pt paste disclosed here is used, then it is possible to manufacture piezoelectric ceramic substrates made of PZT or the like having formed thereon conductor layers (conductor films) having high electrical reliability and durability, and piezoelectric elements containing such substrates.

### BRIEF DESCRIPTION OF THE DRAWINGS

FIG. 1 is a sectional view showing schematically a typical form of a laminate type piezoelectric element; and

FIG. 2 is a graph showing the change in resistance upon repeated heat treatment for each of a conductor film of an example of the present invention and a conductor film of a comparative example.

### DESCRIPTION OF THE PREFERRED EMBODIMENTS

Following is a detailed description of preferred embodiments of the present invention. Note that technical matters that are required for carrying out the present invention but are not particularly mentioned in the present specification are matters of design variation that could be apprehended by a person skilled in the art based on prior art. The present invention can be carried out based on the technical details disclosed in the present specification and drawings and on common general technical knowledge in the field in question.

A preferable Pt paste disclosed here is a Pt paste that contains a rare earth oxide having a prescribed particle size range; there are no particular limitations on the composition or the content of other auxiliary components so long as the objects mentioned earlier can be attained.

The Pt paste contains platinum, which is a precious metal powder, as a principal component. There are no particular limitations on the particle size of the platinum, but from the viewpoint of forming a dense conductor film (baked film), it is preferable to use fine platinum particles having a mean particle size (according, for example, to actual observation using a scanning electron microscope (SEM)) of approximately 2.0 μm or less (preferably approximately 0.1 to approximately 1.0 μm). Moreover, it is particularly preferable to use fine platinum particles that have such a small mean particle size, and moreover have a relatively narrow particle size distribution, with substantially no particles of size approximately 10 μm or more (particularly preferably approximately 5 μm or more) being contained. In particular, if two or more types of platinum particles having different mean particle sizes, for example platinum particles having a mean particle size of approximately 0.1 to approximately 0.5 μm (preferably approximately 0.1 to approximately 0.3 μm) and platinum particles having a mean particle size of approximately 0.6 to approximately 1.0 μm (preferably approximately 0.7 to approximately 0.9 μm), are used together, then a denser conductor film (baked film) can be formed.

The platinum powder itself may be manufactured using a manufacturing method that has been publicly known from hitherto; there is no need for special manufacturing means. For example, platinum particles manufactured using a well known reduction precipitation method, vapor phase reaction method, gas reduction method or the like can be used. Moreover, a commercially sold platinum powder of the desired particle size and purity may be used. Moreover, a platinum powder containing small amounts of metallic components other than platinum (e.g. precious metals such as palladium, base metals such as nickel) may be used.

Moreover, there are no particular limitations on the content of the conductor component that consists predominantly of the platinum (and also contains the rare earth oxide, described later) in the conductor paste, but this content is preferably approximately 50 to approximately 90 mass %, more preferably approximately 70 to approximately 90 mass %, particularly preferably approximately 75 to approximately 85 mass %, of the whole of the paste. If the content of the conductor component that consists predominantly of the platinum exceeds approximately 90 mass % of the whole of the paste, then there will tend to be a drop in the wettability of the paste to the ceramic material, whereas if this content is less than approximately 50 mass %, then the electrical conductivity will tend to be poor.

The preferable Pt paste disclosed here contains a rare earth oxide having a mean particle size in a range of approximately 10 to approximately 100 nm. Examples of the rare earth oxide include scandium oxide, yttrium oxide, lanthanum oxide, cerium oxide, praseodymium oxide, neodymium oxide, promethium oxide, samarium oxide, europium oxide, gadolinium oxide, terbium oxide, dysprosium oxide, holmium oxide, erbium oxide, thulium oxide, ytterbium oxide and lutetium oxide.

Of these, an oxide of a cerium group (light rare earth) metal such as cerium oxide is preferable. Moreover, yttrium oxide has a good heat resistance improving effect, and is thus also preferable. One oxide may be added, or two or more oxides mixed together may be added.

The mean particle size of the rare earth oxide powder is in a range of approximately 10 to approximately 100 nm, preferably approximately 20 to approximately 80 nm, more preferably approximately 30 to approximately 70 nm. Through the mean particle size of the rare earth oxide being in such a prescribed range, the wettability of the solid component in the Pt paste to the piezoelectric ceramic material becomes extremely good. If the mean particle size of the rare earth oxide powder is less than approximately 10 nm, then a marked improvement in the wettability cannot be expected. On the other hand, it is undesirable for the mean particle size of the rare earth oxide powder to exceed approximately 100 nm, since then the electrical conductivity of the conductor film obtained will drop.

As the rare earth oxide powder, a commercially sold rare earth oxide powder having a prescribed particle size range as above may be used, or a rare earth oxide powder manufactured using any means known from hitherto may be used.

The amount used of the rare earth oxide is preferably approximately 0.1 to approximately 3 parts by mass, more preferably approximately 0.3 to approximately 2 parts by mass, particularly preferably approximately 0.5 to approximately 1 parts by mass, per 100 parts by mass of the platinum component (metal powder).

Although there are no particular limitations, it is suitable for the content of the rare earth oxide to be approximately 0.05 to approximately 3 mass % of the whole of the paste, with approximately 0.1 to approximately 2.0 mass % being more preferable, and approximately 0.2 to approximately 1.0 mass % being particularly preferable. It is undesirable for this content to be less than approximately 0.05 mass %, since then there will be little improvement in the wettability. On the other hand, it is undesirable for this content to exceed approximately 3.0 mass %, since then the electrical conductivity of the conductor film obtained will tend to drop.

An example of a preferable auxiliary component that can be put into the Pt paste of the present invention is an organic medium (vehicle) for dispersing the metal powder and the rare earth oxide powder. When carrying out the present invention, it is sufficient if the organic medium is one in which the metal powder can be dispersed; organic medium used in conductor pastes (with the metallic component not being limited to platinum) hitherto can be used with no particular limitations thereon. Examples are cellulose type polymers such as ethyl cellulose, high-boiling-point organic solvents such as ethylene glycol, diethylene glycol and derivatives thereof, toluene, xylene, mineral spirit, butyl carbitol, and terpineol, and combinations of two or more thereof. Preferable examples are ethyl cellulose, terpineol, and a mixed liquid of ethyl cellulose and terpineol (preferably in a volume ratio of 1:1). A suitable content of the organic medium is approximately 10 to approximately 50 mass % of the whole of the paste, with approximately 10 to approximately 30 mass % being preferable, and approximately 15 to approximately 25 mass % being particularly preferable.

Moreover, in addition to the rare earth oxide powder, any of various other inorganic additives can be put into the Pt paste as auxiliary components, so long as there is no marked impairment of the intrinsic heat resistance, electrical conductivity and so on. Examples of such inorganic additives include inorganic oxides other than rare earth oxides, glass powders, and various other fillers.

Specifically, such another inorganic oxide or a glass powder can act as an inorganic component (inorganic binder) that contributes to stably baking and fixing paste components attached onto a substrate made of a piezoelectric ceramic material such as PZT (i.e. improves the adhesive strength). The other inorganic oxide or glass powder used preferably has a specific surface area of approximately 0.5 to 50 m²/g, and particularly preferably has a mean particle size of approximately 2 μm or less (especially preferably approximately 1 μm or less), since then the good electrical conductivity will not be impaired.

In the case of adding such another inorganic oxide or glass powder as an inorganic additive, the content thereof is preferably approximately 0.5 to approximately 10 mass % of the whole of the paste; if the amount added is low in this way, then an improvement in the adhesive strength of the baked material obtained from the Pt paste (the conductor film) to the piezoelectric ceramic substrate can be realized, with substantially no impairment of the good electrical conductivity of the Pt paste.

Note that the above numerical ranges relating to the contents and mixing ratios of the various components should not be taken strictly, but rather some deviation from these ranges is permitted so long as the objects of the present invention can be attained.

Moreover, any of various organic additives can be put into the Pt paste disclosed here as auxiliary components, so long as there is no impairment of the intrinsic electrical conductivity and heat resistance of the paste. Examples include various organic binders, and various coupling agents such as silicon-based and aluminum-based coupling agents whose purpose is to improve the adhesion to the ceramic substrate.

Examples of organic binders are ones having as a base thereof, for example, an acrylic resin, an epoxy resin, a phenol resin, an alkyd resin, a cellulose type polymer, polyvinyl alcohol or the like. An organic binder able to give the Pt paste good viscosity and coating film-forming ability is suitable. Moreover, in the case of wishing to make the Pt paste photocurable (photosensitive), any of various photopolymerizable compounds and photopolymerization initiators may be added as required.

Furthermore, in addition to the above, surfactants, antifoaming agents, platicizers, thickeners, antioxidants, dispersants, polymerization inhibitors and so on can be added to the Pt paste disclosed here as required. These additives should be ones that can be used in the preparation of conventional conductor pastes, and hence detailed description will be omitted here.

As described above, the Pt paste of the present invention has excellent heat resistance, and hence can be suitably used for forming a conductor film on a ceramic material made of PZT for which changes in properties upon baking are relatively large. In particular, the Pt paste of the present invention is suitable for applications in which baking is carried out in a PZT-containing atmosphere, in which sintering proceeds readily and there are marked changes in properties upon the baking. A PZT-containing atmosphere can be, for example, a high-pressure high-temperature atmosphere containing PbO, ZrO₂ and TiO₂ vapors, or PbZrO₃ vapor with excess Pb vapor. It is preferable, for example, to carry out baking in an atmosphere containing such vapors with a pressure condition of approximately 80 to approximately 200 kg/cm² (approximately 8 to approximately 20 MPa), preferably approximately 100 to approximately 140 kg/cm² (approximately 10 to approximately 14 MPa), for example approximately 110 to approximately 130 kg/cm² (approximately 11 to approximately 13 MPa), and a temperature condition of approximately 800 to approximately 1500° C. (preferably approximately 1000 to approximately 1300° C., for example approximately 1100 to approximately 1300° C.).

There are no particular limitations on the baking time, but this time should be a time sufficient for sintering, for example approximately 1 to approximately 10 hours, preferably approximately 3 to approximately 7 hours, particularly preferably approximately 5 to approximately 6 hours.

Typically, the Pt paste disclosed here can be prepared as with a conventional conductor paste, i.e. by mixing together the platinum powder, the rare earth oxide having a prescribed particle size range, and the organic medium. At this time, additives as described above may be added and mixed in as required. For example, using a three-roller mill or other kneader, the platinum powder, the rare earth oxide powder, and various desired additives are mixed together with the organic medium in prescribed mixing proportions, and are kneaded together, whereby the targeted Pt paste can be obtained.

The Pt paste of the present invention can be handled in the same way as conductor pastes that have been used hitherto for forming conductor films such as internal electrodes on green sheets made of a piezoelectric ceramic (dielectric) such as PZT or barium titanate; regarding the means for applying the paste onto the substrate, a method publicly known from hitherto can be used with no particular limitations thereon. Typically, the Pt paste is applied onto a piezoelectric ceramic substrate in a desired wiring pattern and to a desired thickness using a screen printing method, a dispenser application method or the like. Next, drying is preferably carried out, and then heating is carried out for a prescribed time under suitable heating conditions, typically at approximately 800 to approximately 1500° C., particularly preferably approximately 1200 to approximately 1400° C., in a heater (baking furnace), whereby the solid component is baked and hardened, and hence a conductor film is formed.

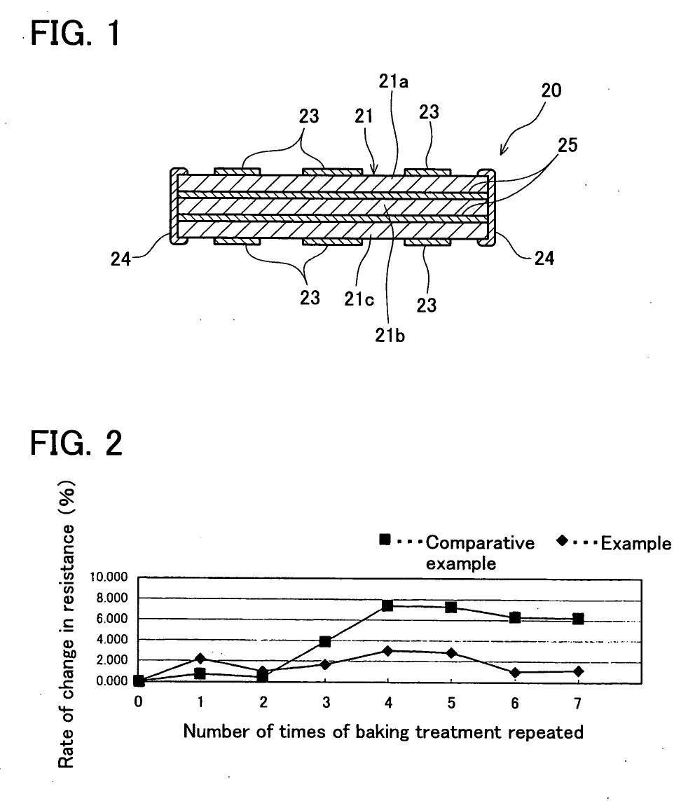

In the case of forming a laminate type piezoelectric element 20 as shown in FIG. 1, the manufacture can typically be carried out using a procedure like the following.

The Pt paste of the present invention is applied onto a plurality of piezoelectric ceramic substrates (green sheets) 21a, 21b and 21c made of PZT or the like, whereby conductor films (internal electrodes) 25 that will form an internal wiring pattern are formed. The plurality of green sheets 21a, 21b and 21c on which the conductor films have been formed are then laminated and pressed together. Note that, as shown in FIG. 1, surface conductor films (surface electrodes) 23 may also be formed using a suitable conductor paste on the surfaces of the laminate 21 as required.

Next, the laminate 21 obtained is baked within a suitable temperature range as described above not exceeding the melting point of platinum. The baking may be carried out in an ordinary air atmosphere, or may be carried out in an atmosphere as described above. After the baking, a suitable conductor paste is applied onto sides (end faces) of the laminate 21 to form external conductor films (external electrodes) 24, and heating is carried out to within a prescribed temperature range, thus baking the external conductor films (external electrodes) 24.

Through this processing sequence, the targeted laminate type piezoelectric element 20 can be manufactured. Note that the above description was for an example in which the green sheets 21a, 21b and 21c are built up in order while forming the conductor films (internal electrodes) 25, and then finally all of them are baked together; however, there is no limitation to this, but rather a method in which the application of the Pt paste and baking are repeated each time a green sheet is laminated on (a repeated baking method) may also be carried out (this corresponds to the second method described earlier). Note that this laminated ceramic substrate manufacturing process itself is not what particularly characterizes the present invention, and hence further detailed description will be omitted.

### EXAMPLES

The present invention will now be described in more detail through examples; however, the present invention is not intended to be limited to these examples.

### Example 1

### Preparation of Pt Paste (1)

In the present example, a platinum powder having a mean particle size of 0.2 μm and a platinum powder having a mean particle size of 0.8 μm were used to constitute the platinum powder. These two types of platinum powder having a different particle size distribution were weighed out in a mass ratio of 1:1, and mixed together thoroughly.

A cerium oxide powder was used as the rare earth oxide powder. The mean particle size thereof was measured to be approximately 60 nm using a scanning electron microscope (SEM). A mixed liquid of ethyl cellulose and α-terpineol in a volume ratio of 1:1 was used as the organic medium (vehicle).

Using a three-roller mill, these raw materials were kneaded together in amounts of 80 mass % of the platinum powder, 0.8 mass % of the cerium oxide (i.e. a proportion of 1 part per 100 parts of the platinum powder), and 19.2 mass % of the vehicle, relative to the total amount of the platinum powder, the cerium oxide powder and the vehicle (100 mass %). The Pt paste of Example 1 was thus prepared.

### Comparative Example 1

### Preparation of Pt Paste Having Different Cerium Oxide Particle Size

Cerium oxide was used as the rare earth oxide. The mean particle size thereof was measured to be approximately 0.4 μm (400 nm) using an SEM. Using this cerium oxide powder, and the same platinum powder and vehicle as in Example 1, processing was carried out as in Example 1, thus preparing the Pt paste of Comparative Example 1. That is, the Pt paste of Example 1 and the Pt paste of Comparative Example 1 differed only in the particle size distribution of the cerium oxide powder used.

### Formation of Conductor Films

Next, using each of the Pt paste of Example 1 and the Pt paste of Comparative Example 1, a conductor film was formed on the surface of a PZT piezoelectric ceramic substrate (thickness: approximately 0.5 mm). Specifically, each of the conductor pastes of Example 1 and Comparative Example 1 was applied onto the surface of a PZT piezoelectric ceramic substrate using an ordinary screen printing method, thus forming a coating film of thickness approximately 4 μm.

Next, drying was carried out for 15 minutes at 100° C. using a far infrared dryer. Through this drying, the vehicle was evaporated off from the coating film, and hence a conductor film made of an unbaked conductor component was formed on the ceramic substrate.

Next, the conductor film was baked together with the PZT piezoelectric ceramic substrate. Specifically, baking was carried out for 2 hours at 1300° C. in an electric furnace. Through this baking, a conductor film of thickness approximately 2 μm was baked onto the PZT piezoelectric ceramic substrate. When merely ‘conductor film’ is stated in the following, this refers to this baked conductor film.

### Evaluation of Conductor Films

To evaluate the characteristics of each of the conductor films obtained as described above, the resistance and the change in film quality were tested/measured as follows. The resistance was measured using a digital multimeter made by Advantest Corporation. On the other hand, the surface roughness Ra was taken as an indicator of the change in the film quality, and was measured using a ‘Surfcom’ (registered trademark) surface roughness meter made by Tokyo Seimitsu Co., Ltd.

Each of the conductor films obtained was subjected to repeated heat treatment seven times under the same conditions as in the baking treatment described above, and the characteristic values, i.e. the resistance and the surface roughness Ra, were measured as described above during this, and the changes therein were investigated. For the resistance, the rate of change of the resistance upon the repeated heat treatment from the original resistance for the baked conductor film was calculated; the transition of this change in the resistance is shown as a graph in FIG. 2. The diamond-shaped points in the graph are the results for the conductor film obtained from the Pt paste of Example 1, and the square points in the graph are the results for the conductor film obtained from the Pt paste of Comparative Example 1.

On the other hand, the results for the change in the surface roughness Ra are shown in Table 1.

TABLE 1

(Change in surface roughness Ra)

| | Number of times of baking carried out | | |
|---|---|---|---|
| | | After repeated | After repeated |
| | After | heat treatment | heat treatment |
| | initial baking | carried out 1^{st} time | carried out 2^{nd} time |
| Example 1 | 0.16 μm | 0.16 μm | 0.16 μm |
| Comparative | 0.16 μm | 0.20 μm | 0.22 μm |
| Example 1 | | | |

As is clear from the graph of FIG. 2, for the conductor film obtained from the Pt paste of Comparative Example 1, the resistance of the conductor film increased upon carrying out the repeated heat treatment three times, with the rate of change being approximately 4%. Furthermore, upon repeating the heat treatment a fourth time and beyond, the resistance further increased, with the rate of change rising to 6 to 8%. In contrast with this, for the conductor film obtained from the Pt paste of Example 1, it was found that there was very little change in the resistance, with the rate of change of the resistance being only approximately I to 3% even upon carrying out the heat treatment seven times.

Moreover, as is clear from the results in Table 1, the surface roughness Ra of the conductor film obtained from the Pt paste of Comparative Example 1 gradually increased from a reference value of 0.16 μm before the repeated heat treatment to 0.20 μm after the heat treatment had been carried out the first time and 0.22 μm after the heat treatment had been carried out the second time, and moreover bubbling and peeling off from the substrate were seen upon observing with the naked eye or a stereoscopic microscope. In contrast with this, for the conductor film obtained from the Pt paste of Example 1, no change in the surface roughness Ra was seen even upon carrying out the heat treatment twice.

### Examples 2 to 7

### Preparation of Pt Pastes

Using any of various rare earth oxides in a prescribed amount as shown in Table 2, various Pt pastes (Examples 2 to 7) were manufactured as in Example 1. Note that in all of the examples, the content of the platinum component was made to be 80 mass % of the whole of the paste, and the amount of the vehicle mixed in was adjusted as appropriate in accordance with the change in the content of the rare earth oxide, so that with these three components the total amount of the paste became 100 mass %. As shown in Table 2, for Example 2, Example 5 and Example 6, the same cerium oxide as in Example 1 was used. For Example 3, neodymium oxide was used. The mean particle size thereof was approximately 70 nm according to SEM measurement results. For Example 4 and Example 7, yttrium oxide was used. The mean particle size thereof was approximately 50 nm according to SEM measurement results. The content (mass %) of the rare earth oxide used in each example relative to the whole of the paste and the amount added (mixing proportion) per 100 parts of platinum are shown in Table 2.

TABLE 2

| | | | Amount | | | | |
|---|---|---|---|---|---|---|---|
| | | | added | | Temperature | Temperature | Atmosphere |
| | Oxide | Oxide | per 100 parts | | of initial | of repeated | for heat |
| Paste | type | content | of platinum | | baking | heat treatment | treatment |
| Control | None | — | — | | 1350° C. | 1350° C. | Air |
| Example 2 | CeO₂ | 0.8% | 1 | part | 1350° C. | 1350° C. | Air |
| Example 3 | Nd₂O₃ | 0.8% | 1 | part | 1350° C. | 1350° C. | Air |
| Example 4 | Y₂O₃ | 0.8% | 1 | part | 1350° C. | 1350° C. | Air |
| Example 5 | CeO₂ | 0.4% | 0.5 | parts | 1300° C. | 1300° C. | Air |
| Example 6 | CeO₂ | 0.8% | 1 | part | 1350° C. | 1350° C. | PZT |
| Example 7 | Y₂O₃ | 0.8% | 1 | part | 1350° C. | 1350° C. | PZT |
| Comparative | ZrO₂ | 0.8% | 1 | part | 1350° C. | 1350° C. | Air |
| Example 2 | | | | | | | |
| Comparative | Al₂O₃ | 0.8% | 1 | part | 1350° C. | 1350° C. | Air |
| Example 3 | | | | | | | |
| Comparative | Bi₂O₃ | 0.3% | 0.4 | parts | 1300° C. | 1300° C. | Air |
| Example 4 | | | | | | | |
| Comparative | CuO | 0.3% | 0.4 | parts | 1300° C. | 1300° C. | Air |
| Example 5 | | | | | | | |
| Comparative | ZrO₂ | 0.8% | 1 | part | 1350° C. | 1350° C. | PZT |
| Example 6 | | | | | | | |
| Comparative | Al₂O₃ | 0.8% | 1 | part | 1350° C. | 1350° C. | PZT |
| Example 7 | | | | | | | |

### Comparative Examples 2 to 7

### Preparation of Pt Pastes Having Oxides of Groups Other Than Group 3A Added Thereto

As Comparative Examples 2 to 7, using any of various oxides other than rare earth oxides in a prescribed amount as shown in Table 2, various Pt pastes were manufactured as in Example 1. Note that in all of the comparative examples, the content of the platinum component was made to be 80 mass % of the whole of the paste, and the amount of the vehicle mixed in was adjusted as appropriate in accordance with the change in the content of the oxide, so that with these three components the total amount of the paste became 100 mass %. As shown in Table 2, for Comparative Example 2 and Comparative Example 6, zirconium oxide was used. The mean particle size thereof was approximately 100 nm according to SEM measurement results. For Comparative Example 3 and Comparative Example 7, aluminum oxide was used. The mean particle size thereof was approximately 60 nm according to SEM measurement results. For Comparative Example 4, bismuth oxide was used. The mean particle size thereof was approximately 70 nm according to SEM measurement results. For Comparative Example 5, copper oxide was used. The mean particle size thereof was approximately 60 nm according to SEM measurement results. Moreover, as a control, a Pt paste not containing any of the oxides (platinum 80 mass %, vehicle 20 mass %) was manufactured as in Example 1.

### Formation of Conductor Films

Next, using the Pt paste of each of the examples and comparative examples, a conductor film of thickness approximately 2 μm was formed on the surface of a PZT piezoelectric ceramic substrate through the same procedure as in the case described earlier in which the Pt pastes of Example 1 and Comparative Example 1 were used. Note that the temperature and atmosphere when carrying out the baking and the repeated heat treatment varied in accordance with the Pt paste used as shown in Table 2. As shown in Table 2, for Examples 6 and 7 and Comparative Examples 6 and 7, a PZT-containing atmosphere was used as the atmosphere for the heat treatment. The PZT-containing atmosphere used here refers, basically, to an atmosphere with the following composition and conditions. That is, approximately 20 g of a PZT powder was put into a highly gas-tight vessel made of Al₂O₃ (approximately 200 cm³), and was subjected to the heat treatment with the sample.

### Evaluation of Conductor Films

Next, as in the case of the conductor film described earlier manufactured using the Pt paste of Example 1, the surface roughness Ra for each of the conductor films was measured after the baking and after carrying out the repeated heat treatment once, twice and three times. Moreover, it was visually observed whether or not bubbling occurred on each of the conductor films. Furthermore, for the conductor film manufactured using the Pt paste of each of Examples 2 to 5 and Comparative Examples 2 to 5, the strength of adhesion to the substrate was measured. Specifically, the strength of adhesion (kg/(2 mm)²) to the ceramic substrate was measured in accordance with the following tensile strength test.

That is, a lead wire (tin-plated copper wire) was soldered to a 2 mm×2 mm square conductor film formed on the ceramic substrate. After that, this lead wire was pulled with a prescribed force in a direction perpendicular to the plane of the substrate, and the load (kg) when the joined surface broke (divided into parts) was taken as the strength of adhesion (kg/(2 mm)²).

The results are shown in Table 3. Note that, in Table 3, for the bubbling, “A” indicates that bubbling was not observed, “B” indicates that bubbling occurred slightly, and “C” indicates that marked bubbling was observed.

TABLE 3

| | | | Repeated heat treatment | | |
|---|---|---|---|---|---|
| | | After | After | After | After |
| Paste used | Evaluated property | initial baking | 1^{st} time | 2^{nd} time | 3^{rd} time |
| Control | Surface roughness Ra (μm) | 0.16 | 0.20 | 0.20 | 0.22 |
| | Strength of adhesion to | 1.8 | 1.0 | — | 0.5 |
| | substrate (kg/(2 mm)²) | | | | |
| | Bubbling | A | B | C | C |
| Example 2 | Surface roughness Ra (μm) | 0.16 | 0.16 | 0.16 | 0.16 |
| | Strength of adhesion to | 2.5 | 2.4 | — | 2.5 |
| | substrate (kg/(2 mm)²) | | | | |
| | Bubbling | A | A | A | A |
| Example 3 | Surface roughness Ra (μm) | 0.16 | 0.16 | 0.16 | 0.16 |
| | Strength of adhesion to | 2.2 | 2.2 | — | 2.1 |
| | substrate (kg/(2 mm)²) | | | | |
| | Bubbling | A | A | A | A |
| Example 4 | Surface roughness Ra (μm) | 0.16 | 0.16 | 0.16 | 0.16 |
| | Strength of adhesion to | 2.2 | 2.1 | — | 2.2 |
| | substrate (kg/(2 mm)²) | | | | |
| | Bubbling | A | A | A | A |
| Example 5 | Surface roughness Ra (μm) | 0.16 | 0.16 | 0.16 | 0.16 |
| | Strength of adhesion to | 2.4 | — | — | 2.3 |
| | substrate (kg/(2 mm)²) | | | | |
| | Bubbling | A | A | A | A |
| Example 6 | Surface roughness Ra (μm) | 0.16 | 0.16 | 0.16 | 0.16 |
| | Bubbling | A | A | A | A |
| Example 7 | Surface roughness Ra (μm) | 0.16 | 0.16 | 0.18 | 0.18 |
| | Bubbling | A | A | A | A |
| Comparative | Surface roughness Ra (μm) | 0.16 | 0.18 | 0.18 | 0.20 |
| Example 2 | Strength of adhesion to | 2.5 | 2.0 | — | 1.1 |
| | substrate (kg/(2 mm)²) | | | | |
| | Bubbling | A | B | B | C |
| Comparative | Surface roughness Ra (μm) | 0.16 | 0.16 | 0.18 | 0.22 |
| Example 3 | Strength of adhesion to | 2.3 | 2.0 | — | 0.9 |
| | substrate (kg/(2 mm)²) | | | | |
| | Bubbling | A | B | C | C |
| Comparative | Surface roughness Ra (μm) | 0.18 | 0.22 | 0.24 | 0.24 |
| Example 4 | Strength of adhesion to | 2.4 | — | — | 0.5 |
| | substrate (kg/(2 mm)²) | | | | |
| | Bubbling | A | C | C | C |
| Comparative | Surface roughness Ra (μm) | 0.18 | 0.20 | 0.24 | 0.24 |
| Example 5 | Strength of adhesion to | 2.8 | — | — | 0.5 |
| | substrate (kg/(2 mm)²) | | | | |
| | Bubbling | A | C | C | C |
| Comparative | Surface roughness Ra (μm) | 0.16 | 0.22 | 0.28 | 0.32 |
| Example 6 | Bubbling | A | C | C | C |
| Comparative | Surface roughness Ra (μm) | 0.16 | 0.24 | 0.32 | 0.32 |
| Example 7 | Bubbling | A | C | C | C |

As is clear from Table. 3, with each of the conductor films formed from the Pt paste used as a control and the Pt pastes of Comparative Examples 2 to 5, the surface roughness Ra increased markedly upon the heat treatment. Moreover, upon carrying out the heat treatment repeatedly, the strength of adhesion to the substrate dropped dramatically to 50 to 20% or less of the reference value. Furthermore, considerable bubbling was also observed.

In contrast to this, with each of the conductor films formed from the Pt pastes of Examples 2 to 6, the surface roughness Ra did not change at all. Furthermore, the strength of adhesion to the substrate hardly changed, and no conspicuous bubbling was observed.

Moreover, under heat treatment conditions in a PZT-containing atmosphere in which changes in properties due to sintering are marked, with each of the conductor films formed from the Pt pastes of Comparative Examples 6 and 7, the surface roughness Ra had already increased markedly after carrying out the repeated heat treatment the first time, and became almost double the original value after carrying out the repeated heat treatment the third time. Furthermore, considerable bubbling was already observed after carrying out the repeated heat treatment the first time. In contrast with this, with each of the conductor films formed from the Pt pastes of Examples 6 and 7, the surface roughness Ra had hardly changed even after carrying out the repeated heat treatment the third time. Moreover, bubbling was also not observed.

In the above examples, concrete examples of the present invention were described in detail; however, these examples are merely illustrative, and do not restrict the scope of the claims. Any of various modifications or changes to the concrete examples given above are deemed to be included in the art described in the claims.

Moreover, the technical elements described in the present specification and drawings exhibit technical usefulness either alone or in any of various combinations, and there is no limitation to the combinations described in the claims at the time of filing. Moreover, the art illustrated in the present specification and drawings attains a plurality of objects simultaneously, but has technical usefulness in attaining one of these objects.

What is claimed is:

1. A conductor composition prepared in the form of an ink or a paste that is suitable for forming a conductor film on a piezoelectric ceramic material, the conductor composition comprising:
a platinum powder that is a principal conductor-forming component; and
a rare earth oxide powder having a mean particle size in a range of approximately 10 to approximately 100 nm.

2. The conductor composition according to claim 1, containing said rare earth oxide powder in a proportion of approximately 0.1 to approximately 3 parts by mass per 100 parts by mass of said platinum powder.

3. The conductor composition according to claim 1, containing yttrium oxide as said rare earth oxide powder.

4. The conductor composition according to claim 1, containing at least one cerium group rare earth oxide as said rare earth oxide powder.

5. A method of forming a conductor film baked on a piezoelectric ceramic material, the method comprising the steps of:
preparing a conductor composition prepared in the form of an ink or a paste comprising a platinum powder that is a principal conductor-forming component, and a rare earth oxide powder having a mean particle size in a range of approximately 10 to approximately 100 nm;
applying said composition onto a substrate made of a piezoelectric ceramic material; and
baking said substrate onto which said composition has been applied.

6. The method according to claim 5, wherein a ceramic material constituted substantially from PZT is used for said substrate.

7. The method according to claim 6, wherein the baking is carried out in an atmosphere containing PZT.

8. A method of manufacturing a piezoelectric element, the method comprising the steps of:
preparing a conductor composition prepared in the form of an ink or a paste comprising a platinum powder that is a principal conductor-forming component, and a rare earth oxide powder having a mean particle size in a range of approximately 10 to approximately 100 nm;
applying said composition onto a substrate made of a piezoelectric ceramic material; and
baking said substrate onto which said composition has been applied.

9. The method according to claim 8, wherein a ceramic material constituted substantially from PZT is used for said substrate.

10. The method according to claim 9, wherein the baking is carried out in an atmosphere containing PZT.
